(19) United States
(12) Patent Application Publication
(10) Pub. No.: US 2008/0223222 A1
(43) Pub. Date: Sep. 18, 2008

(54) Baking or Heating Pot Provided With Adjustable Device For Inner Vapours Breathing

(75) Inventors: Antonio Palamara, Catona (IT); Mariantonia Cotronei, Salice Calabro (IT)

Correspondence Address: BROOKS KUSHMAN P.C., 1000 TOWN CENTER, TWENTY-SECOND FLOOR, SOUTHFIELD, MI, 48075, US

(73) Assignee: DEVELPACK S.R.L., Reggio Calabria (IT)

(21) Appl. No.: 12/089,802

(22) PCT Filed: Oct. 9, 2006
(86) PCT No.: PCT/IT2006/000716

§ 371 Date: Apr. 10, 2008

(30) Foreign Application Priority Data
Oct. 10, 2005 (IT) CZ2005A000013

(51) Int. Cl. A47J 27/08; A47J 37/00; A47J 27/00

(52) U.S. Cl. 99/337; 99/403; 220/573.1

(57) ABSTRACT

Baking or heating pot for food products, comprising a container (1) open in the upper part and a sealing lid (6) associated to it, provided with a device adjustable by the user for the breathing of inner vapours produced during the use of said pot.

### TECHNICAL FIELD OF INVENTION

The present invention regards the field of recipients for baking or heating food. For example, the invention can be used for cooking pastas, rice, cous cous, meat or fish dishes, etc.

### STATE-OF-THE ART

Actually different types of recipients for baking or heating of food products are known.

In particular, as far as microwaves ovens are concerned, the recipients comprise a rigid container, of plastic or glass material, open in the upper part, similar to a soup-plate of various forms (circular, oval etc.), provided with a lid having the breathing devices. The particular disadvantage of such recipients is given by the fact that said breathing devices to be activated by hand before using, realize a permanent communication between outside and inside of the recipient such, that the vapour pressure, produced inside the recipient itself in phase of product balking or heating, has not any influence in terms of reduction of time and efficiency of baking or heating.

Moreover, in case the user forgets to activate said breathing devices before the use, a high increasing of the pressure inside the pot can occur with consequent risks for personal safety and food product integrity, for the pot and baking/heating device.

Such type of pot is majorly used in microwaves ovens, but containers made of material which can be used, for example in traditional ovens, can be realized too. So, the aim of the present invention is that to realize a pot of a simple structure and made preferably using cheep materials and production methods to use for baking or heating which permits a safe realization of adjustable breathing of inner vapours, also for making this cooking or heating more rapid and efficient.

Said aim can be achieved by means of a pot comprising a container open in the upper part and a sealing lid associated to it, characterized by the fact that said lid is partially constituted of elastic material, realized as a unique piece with the lid itself and a valve corp, or fixed to them permanently or in a way to be substituted or removed, where said valve corp includes a handle which allows to adjust the passages of breathing of inner vapours produced during the use of said pot. Moreover, such device comprises an element substained by the lid or by the container, realised in such a way that below a certain pressure value it closes the valve corp, while, superating such value the valve corp linked to the part of elastic material which lifts for effect of vapour pressure enhancing inside the pot separates it from said element, allowing the breathing of vapours outside.

Other characteristics and advantages of the invention will be clear from the following description of invention embodiments given as a non limitative example in FIGS. 1, 2, 3, 4, 5, 6, 7, 8 and 9.

### BRIEF DESCRIPTION OF THE FIGURES

FIG. 1 vertical section of the pot with lid applied and with vapour breathing device in rest position;

FIG. 2 absonometrical view of only valve corp with inserted adjusting handle;

FIG. 3 upper view of complementary element in the valve corp which constitutes the part of breathing device;

FIG. 4 vertical section of the pot with lid, where the device of vapour breathing is in the open position;

FIG. 5 section view of another embodiment of complementary element in the valve corp;

FIG. 6 section view of an embodiment with vapour grill;

FIG. 7 section view of an embodiment with the part of elastic material of substitutable lid;

FIG. 8 section view of another embodiment of sealing coupling between lid and container;

FIG. 9 absonometrical view of the device of FIG. 8.

### DETAILED DESCRIPTION OF THE FIGURES

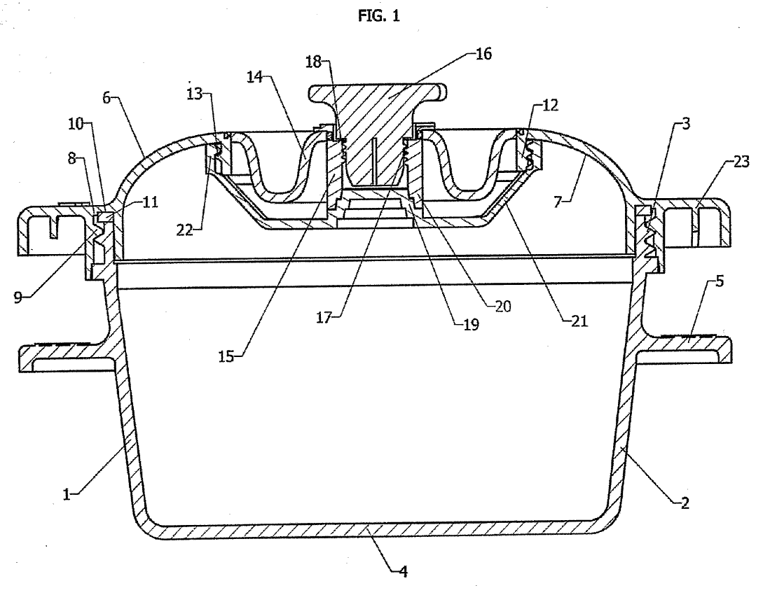

FIG. 1 shows a container (1), for a product to be baked or heated, constituted by an external lateral wall (2), which termins with a thread (3), and with a plain base surface (4).

Said container (1) provided with handles (5) acted to a more easy pot manipulation especially when it is hot, is associated to a lid (6), constituted by a wall (7) limited in the lower part by a double circular edge (8), provided with a thread (9), complementary to the thread (3) of the container (1), with which it is suitable to be coupled, and with a perimetral groove (10), suitable to receive a gasket (11).

As follows, in the lid the internal vapour breathing device is realized. In central superior position said wall (7) presents a cylindrical element (12) provided with a thread (13), to which inner superior end a part of elastic material (14), opportunely shaped by simultaneous molding is fixed.

In the centre of said part of elastic material (14) the valve corp (15) (for example, cylindrical) is, on its turn, fixed by means of, for example, techniques of simultaneous molding, which receives the regulation handle (16), provided with groove (17) complementary to the groove (18) present on the valve corp (15).

In correspondence of the valve corp (15), in the lower part of the lid (6), an element (19), opportunely shaped is placed. It is introduced in a complementary lower portion (20) of the valve corp (15), closing its inferior opening.

Said element (19) is supported in the position mentioned before because it is provided with arms (21), which termins in a grooved wall (22) complementary to the groove (13) to which it is hooked stably.

The lid (6) is, moreover, perimetrally provided with horns (23), suitable to facilitate to the user the opening and closure of the same lid.

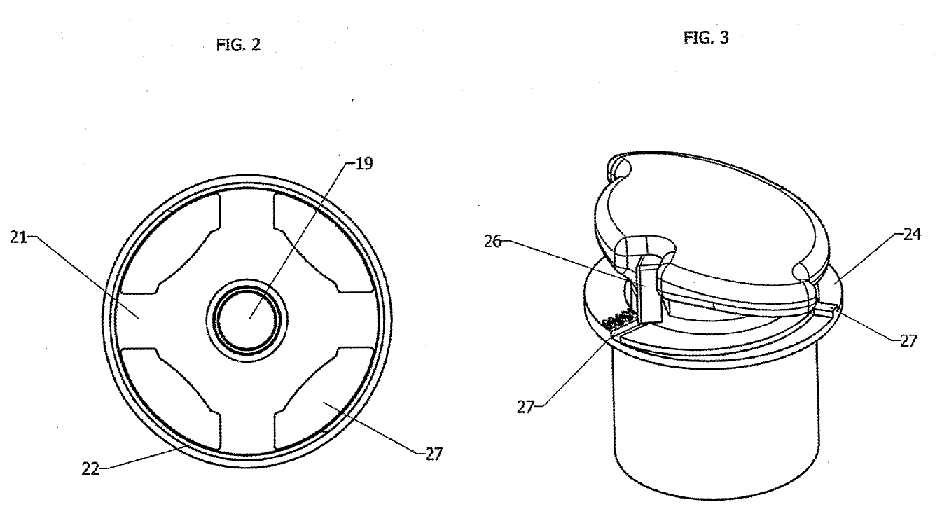

In FIG. 2 it is possible to observe the top of the valve corp, realizable with a flange (24) on which it is possibile to indicate the extreme and intermediate positions of regulation, with eventual related block guides (25) for the element (26) of the handle (16).

Said element (26) of the regulation handle (16) is structured in a way to interfere with valve corp, in order to make possible to realize during the usage, in the position of maximum inner pressure, the flow of vapour between inside and outside of the pot, anyway sufficient to guarantee safety conditions.

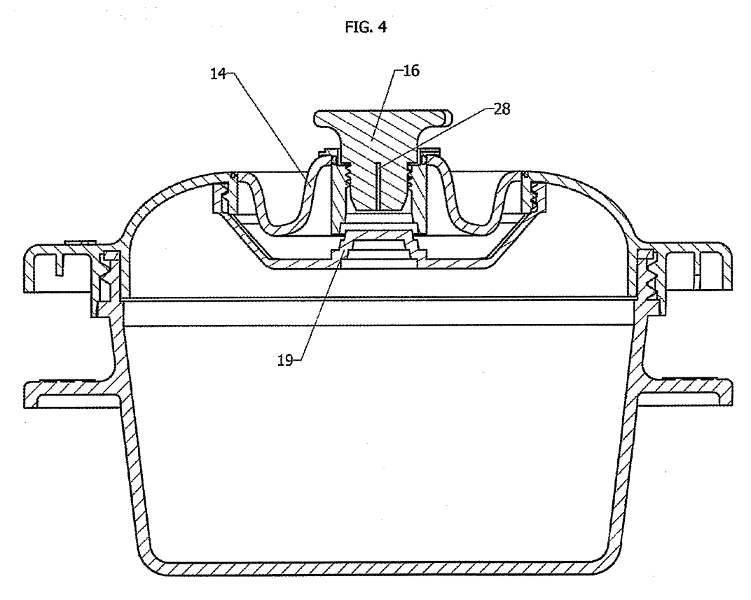

FIG. 3 shows an upper view of the element (19) and related supporting arms (21) which define with the grooved wall (22), the openings (27) of communication between the container (1) and the valve corp.

In FIG. 4 the pot in the usage phase is shown. Precisely, the moment in which the inner pressure is such to determine the lifting of the part of elastic material (14) which pulls in its movement the valve corp fixed to it is shown.

It follows that the lower part of the valve corp mentioned before separates from the complementary element (19), realizing a communication between inside and outside of the pot by means of the passage (28) of the handle (16).

The vapour present in the pot will be able so to flow outside, tending to balance the opposite pressures, but continuing to maintain inside the pot the maximum pressure realizable in base of the regulation realized by the user, with consequent optimisation of time and results.

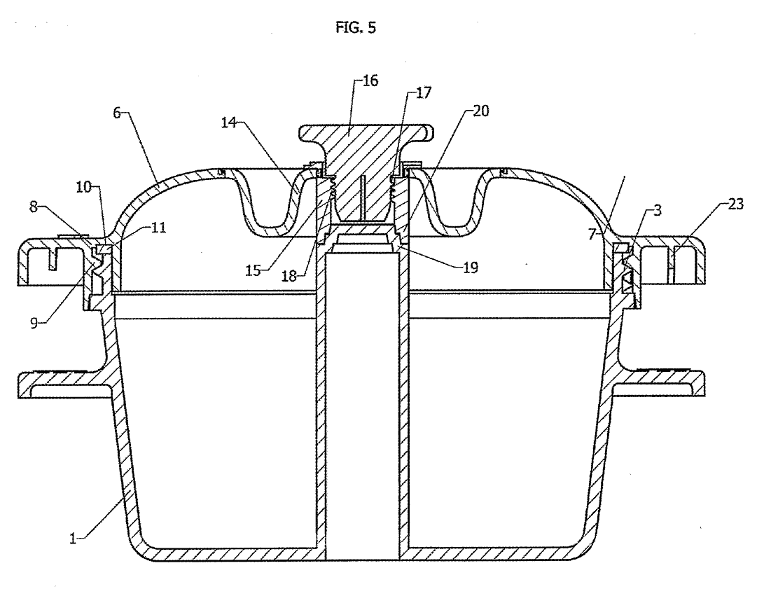

FIG. 5 shows a possible embodiment in which the element (19) is fixed to the container (1).

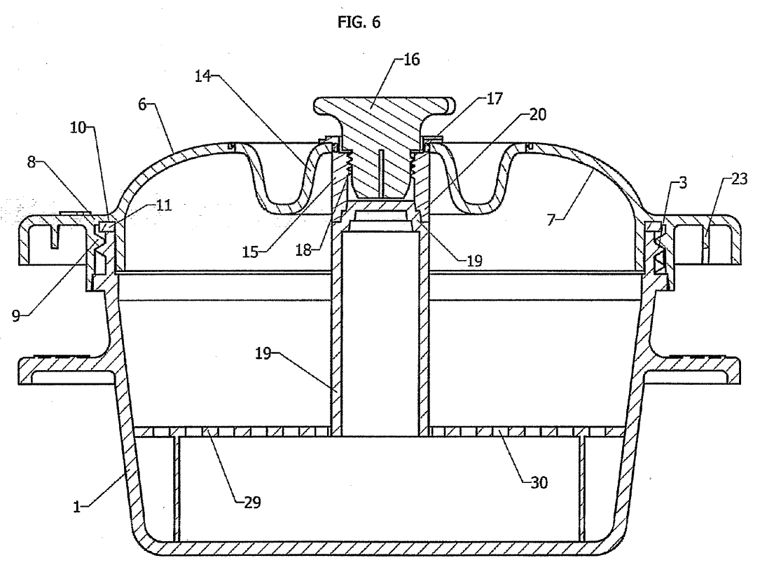

FIG. 6 shows an embodiment in which container (1) is provided with a grill (29), provided with holes (30), usable to separate the food products from liquids, for example, for vapour cooking which comprises also the element (19).

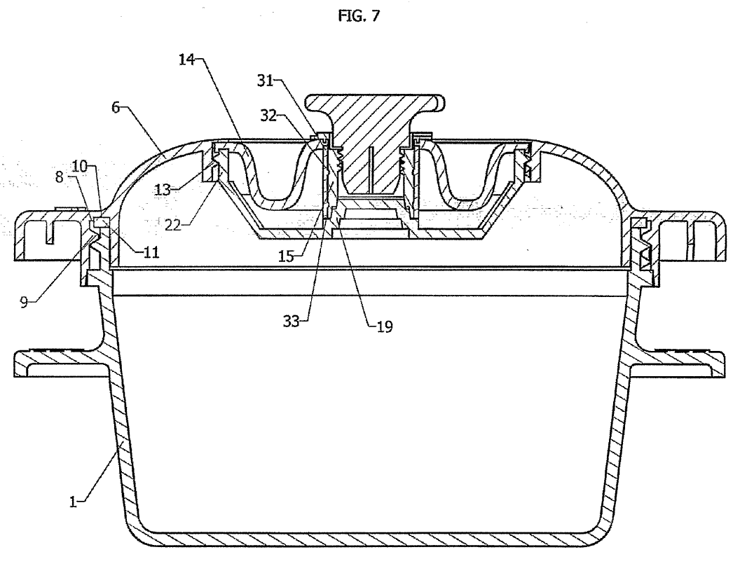

In FIG. 7 an embodiment of the breathing device in which the part of elastic material (14) is not stably fixed to the lid and to the valve corp is described. In fact, it can be removed or, if necessary, substituted, removing both the element (19) from the lid, and the element (31) fixed to the valve corp by means of, for example, the complementary interferences (32) and (33).

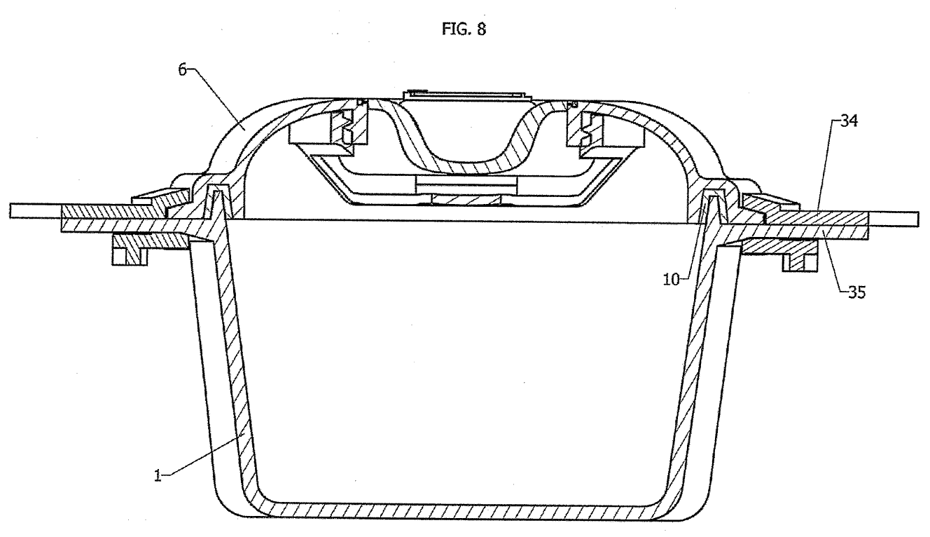

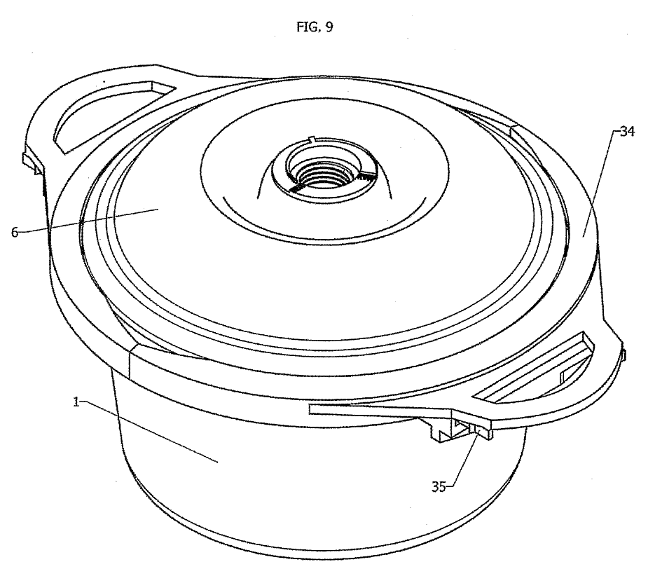

FIGS. 8 and 9 show a particular coupling device between the lid (6) and the container (1). Such device is constituted by blocking elements (34) sliding along the guides (35) present, in this specific case, in the container (1), in order they can be supported also by the lid (6).

In condition of maximum contact with the edges of the lid (6) and of the container (1), shaped for this specific aim, said blocking elements (34) allow to couple a lid and the container sealing them.

The invention, certainly, is not limited, to the representation of the figures, but can receive perfections and modifications from men skilled in the art, without going out of the patent frames.

Present invention permits numerous advantages and, particularly, allows to overcome the difficulties that could not be surmounted using the systems that are actually in commerce.

1. Baking or heating pot for food products, comprising a container, open in the upper part and a sealing lid associated to it, characterized by the fact that said lid is partially constituted of elastic material, that said part is realised as a unique piece with the lid and a valve corp, or fixed to them permanently or in a way to be substituted or removed, that said valve corp includes a handle which allows adjustment of at least one passage enabling fluid communication of an interior of said container with external environment for inner vapours breathing and below a certain pressure value said valve corp is closed by a complementary element, substained by the same lid orbythe container, while, superating such value the elastic portion, lifts for effect of vapour pressure enhancing inside the container, the valve corp is separated from said complementary element, allowing the breathing of vapours outside.

2. Baking or heating pot for food products, according to claim 1, characterized by the fact that said container comprises an external lateral wall, which terminates with a thread.

3. Baking or heating pot for food products, according to claim 2, characterized by the fact that said lid comprises a wall limited in the lower part by a double circular edge, provided with a thread, complementary to the thread of the container with which it is suitable to be coupled, and with a groove about its perimeter, suitable to receive a gasket.

4. Baking or heating pot for food products, according to claim 1, characterized by the fact that said lid is provided with horns at or adjacent its perimeter, to facilitate to the user the opening and closure of the same lid.

5. Baking or heating pot for food products, according to claim 1, characterized by the fact that said lid is provided with guides on which blocking elements can run and in condition of maximum contact with the edges of the lid and of the container, allow to couple a lid and the container sealing them.

6. Baking or heating pot for food products, according to claim 1, characterized by the fact that said valve corp is cylindrical and it is provided with a groove and that said handle is provided with groove complementary to the groove present on the valve corp.

7. Baking or heating pot for food products, according to claim 1, characterized by the fact that said element is provided with arms, which termins in a grooved wall complementary to the groove, realized at the end of the wall of the lid to which said element is hooked stably.

8. Baking or heating pot for food products, according to claim 1, characterized by the fact that said container is provided with a grill, provided with holes usable to separate the food products from liquids, for example, for vapour cooking which comprises also the element.

9. Baking or heating pot for food products, according to claim 1, characterized by the fact that said part of elastic material can be removed or, if necessary, substituted removing both the element from the lid, and the element fixed to the valve corp by means of, for example, complementary interferences.
